(19) United States
(12) Patent Application Publication
(10) Pub. No.: US 2018/0129333 A1
(43) Pub. Date: May 10, 2018

(54) DISPLAY PANEL AND DISPLAY DEVICE

(71) Applicant: XIAMEN TIANMA MICRO-ELECTRONICS CO., LTD., XIAMEN (CN)

(72) Inventors: Chao ZHENG, XIAMEN (CN); Kangpeng YANG, XIAMEN (CN); Yumin XU, XIAMEN (CN)

(73) Assignee: XIAMEN TIANMA MICRO-ELECTRONICS CO., LTD., XIAMEN (CN)

(21) Appl. No.: 15/866,465

(22) Filed: Jan. 10, 2018

(30) Foreign Application Priority Data
Oct. 17, 2017 (CN) 201710966526.9

(51) Int. Cl. G06F 3/041; G06K 9/00

(52) U.S. Cl. CPC G06F 3/0414; G09G 2310/0264; G06F 3/0416; G06K 9/00087

(57) ABSTRACT

The present disclosure provides a display panel and display device relating to the field of display technologies, which can decrease power consumption of the display panel. The display panel includes: one or more first force sensors and one or more second force sensors; a control device, an output end of each first force sensors and an output end of each second force sensors are connected with the control device; an input end of each first force sensors is connected with the control device; and the control device is configured to acquire an output signal of the one or more second force sensors, when the output signal of the one or more second force sensors reaches a first preset condition, a bias voltage is output to the input end of each first force sensors. The present technical solution is mainly applied to the display device with force-sensitive touch function.

### CROSS-REFERENCE TO RELATED APPLICATIONS

The present application claims priority to Chinese Patent Application No. 201710966526.9, filed on Oct. 17, 2017, the content of which is incorporated herein by reference in its entirety.

### TECHNICAL FIELD

The present disclosure relates to the field of display technologies and, in particular, to a display panel and a display device.

### BACKGROUND

In order to achieve a more diverse and flexible way of human-machine interaction, in addition to detection of the touch location, the current touch display panel can also detect the magnitude of the force on the panel. The magnitude of the force on the panel can be detected by a force sensor, and the display panel is usually provided with a plurality force sensors. During the operation of the display panel, a bias voltage is applied to each force sensor to drive the force sensor to work, thereby increasing power consumption during the operation of the display panel.

### SUMMARY

The present disclosure provides a display panel and a display device, which can decrease the power consumption of the display panel.

In one aspect, the present disclosure provides a display panel. The display panel including a control device, one or more first force sensor and one or more second force sensor. Each of the one or more first force sensors includes an input end connected with the control device and an output end connected with the control device. Each of the one or more second force sensors includes an input end and an output end, and the output end of each of the one or more second force sensors are connected with the control device. The control device is configured to acquire an output signal of the one or more second force sensors and, when the output signal of the one or more second force sensors reaches a first preset condition, output a bias voltage to the input end of each of the one or more first force sensors.

In one aspect, the present disclosure provides a display device including the above-described display panel.

As for the display panel and display device provided by the embodiment of the present disclosure, first the input end of the second force sensor is provided with the bias voltage in the force-sensitive pre-detection mode, so that only the second force sensor works in the force-sensitive pre-detection mode while the first force sensor does not work, so the power consumption in the force-sensitive pre-detection mode is relatively low, when the output signal of the second force sensor reaches the first preset condition, it indicates that there is a pressing operation on the display panel, and now the display panel is in the force-sensitive detection mode, and the input end of the first force sensor is provided with the bias voltage, so that a greater number of force sensors can work in the force-sensitive detection mode, thereby improving the accuracy of the force detection, and achieving a more accurate force detection for the display panel. Compared with the prior art, there is no need to provide the bias voltage to all force sensors during the operation of the display panel, thereby decreasing the power consumption of the display panel.

### BRIEF DESCRIPTION OF DRAWINGS

In order to more clearly illustrate technical solutions in embodiments of the present disclosure or in the related art, the accompanying drawings used in the embodiments or in the related art are briefly introduced as follows. Obviously, the drawings described as follows are merely a part of the embodiments of the present disclosure, other drawings can also be acquired by those skilled in the art without paying creative efforts.

FIG. 1 illustrates a structural schematic diagram of a display panel according to an embodiment of the present disclosure;

FIG. 2 illustrates a structural schematic diagram of another display panel according to an embodiment of the present disclosure;

FIG. 3 illustrates a structural schematic diagram of another display panel according to an embodiment of the present disclosure;

FIG. 4 illustrates a structural schematic diagram of another display panel according to an embodiment of the present disclosure;

FIG. 5 illustrates a structural schematic diagram of another display panel according to an embodiment of the present disclosure;

FIG. 6 illustrates a structural schematic diagram of another display panel according to an embodiment of the present disclosure;

FIG. 7 illustrates a structural schematic diagram of another display panel according to an embodiment of the present disclosure;

FIG. 8 illustrates a schematic diagram of a state of another display panel according to an embodiment of the present disclosure;

FIG. 9 illustrates a schematic diagram of a force sensor according to an embodiment of the present disclosure;

FIG. 10 illustrates a schematic diagram of another force sensor according to an embodiment of the present disclosure; and

FIG. 11 illustrates a structural schematic diagram of a display device according to an embodiment of the present disclosure.

### DESCRIPTION OF EMBODIMENTS

The terms used in the embodiments of the present disclosure are merely for the purpose of describing embodiments but not intended to limit the present disclosure. Unless otherwise noted in the context, the singular form expressions “a”, “an”, “the” and “said” used in the embodiments and appended claims of the present disclosure are also intended to represent plural form expressions thereof

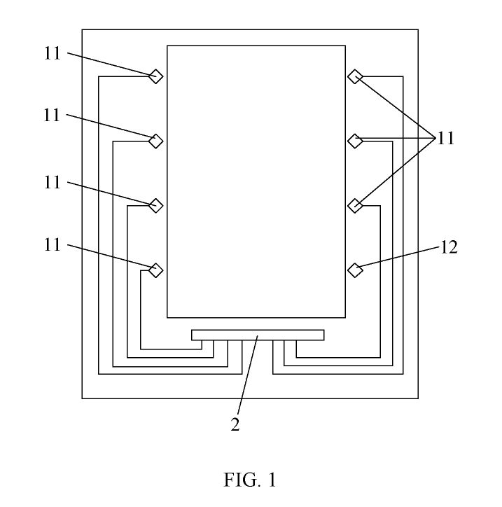

As shown in FIG. 1, FIG. 1 is a structural schematic diagram of a display panel in an embodiment of the present disclosure. The present disclosure provides a display panel, including: one or more first force sensors 11 and one or more second force sensors 12; a control device 2, an output end of each first force sensors 11 and an output end of each second force sensors 12 being connected with the control device 2 (the connection between the output end of the force sensor and the control device 2 is not shown in FIG. 1), an input end of each first force sensors 11 being connected with the control device 2. The control device 2 is configured to acquire an output signal of the one or more second force sensors 12, when the output signal of the one or more second force sensors 12 reaches a first preset condition, a bias voltage is output to the input end of each first force sensors 11.

Each force sensor includes an input end and an output end. The input end of the force sensor is used to acquire the bias voltage, and the force sensor can be driven by the bias voltage to work normally, and when the input end of the force sensor does not acquire the bias voltage, the force sensor may not work; the output end of the force sensor is used to output a signal, and force detection can be carried out according to the signal output from the output end of the force sensor, so as to determine the magnitude of force applied on the display panel. The inventor has found that, when the bias voltage is always applied to all force sensors during the operation of the display panel, the power consumption of the display panel may be greater, in fact, during the operation of the display panel, it takes less time for the user to perform force touch to achieve controlling, and thus there is no need to drive all force sensors to work during the entire working process of the display panel. Based on this, in embodiments of the present disclosure, the force sensors on the display panel is divided into first force sensors 11 and second force sensors 12, the display panel has a force-sensitive pre-detection mode and a force-sensitive detection mode. During the operation of the display panel, firstly the display panel works in the force-sensitive pre-detection mode. In the force-sensitive pre-detection mode, the control device 2 always provides the bias voltage for the input end of the second force sensors 12 to drive the second force sensors 12 to work, and in the pre-detection mode, none of the first force sensors 11 works, when the output signal of the second force sensors 12 reaches the first preset condition, it is decided that there is a pressing operation on the display panel, that is, the user is performing force-sensitive control, and now the display panel enters the force-sensitive detection mode, that is, the control device 2 provides the bias voltage to the input end of the first force sensors 11 so as to drive the first force sensors 11 to work normally, so that a greater number of force sensors in the display panel may work to improve the accuracy of the force detection, thereby achieving a more accurate force detection for the display panel.

As for the display panel in the embodiments of the present disclosure, firstly the input end of the second force sensor is provided with the bias voltage in the force-sensitive pre-detection mode, so that only the second force sensor works in the force-sensitive pre-detection mode while the first force sensor does not work, thus the power consumption in the force-sensitive pre-detection mode is relatively low. When the output signal of the second force sensor reaches the first preset condition, it indicates that there is a pressing operation on the display panel, and now the display panel enters the force-sensitive detection mode, and the input end of the first force sensor is provided with the bias voltage, so that a greater number of force sensors can work in the force-sensitive detection mode, thereby improving the accuracy of the force detection, and achieving a more accurate force detection for the display panel. Compared with the prior art, there is no need to provide the bias voltage to all force sensors during the operation of the display panel, thereby decreasing the power consumption of the display panel.

In an embodiment, the control device 2 is further configured to, when the output signal of one or more second force sensors 12 do not reach the first preset condition within the first preset time, stop outputting the bias voltage to the input end of each first force sensors 11.

In the force-sensitive detection mode, when the output signal of the second force sensors 12 does not reach the first preset condition within the first preset time, it indicates that the force-sensitive operation of the user has ended, in order to further save the power consumption, it is possible to stop outputting the bias voltage to the input end of each first force sensors 11, that is, the display panel re-enters the force-sensitive pre-detection mode, until it is detected for a next time that the output signal of the second force sensors 12 reaches the first preset condition, then the force-sensitive detection mode is re-entered again.

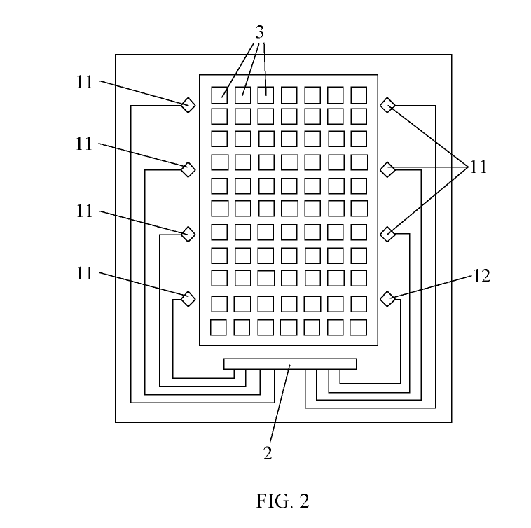

In an embodiment, as shown in FIG. 2, FIG. 2 is a structural schematic diagram of another display panel in an embodiment of the present disclosure. The display panel further includes a touch electrode 3 connected with the control device 2, and the control device 2 is further configured to acquire an output signal of the touch electrode 3 and, when the output signal of the touch electrode 3 reaches a second preset condition, output the bias voltage to the input end of each second force sensors 12.

The touch electrode 3 is configured to detect whether a touch operation is performed on the display panel, and the display panel further includes a touch detection mode. In the touch detection mode, both the first force sensors 11 and the second force sensors 12 do not work while the touch electrode 3 works. When the output signal of the touch electrode 3 reaches the second preset condition, it indicates that there is a touch operation on the display panel. At this time, the control device 2 outputs a bias voltage to the input end of each second force sensors 12, and the second force sensors 12 are driven to work, that is, the force-sensitive pre-detection mode is entered. If the output signal of the second force sensors 12 reaches the first preset condition, it indicates that there is a pressing operation on the display panel. At this time, the control device 2 provides a bias voltage to the input end of the first force sensors 11, that is, the force-sensitive detection mode is entered, so that a greater number of force sensors in the display panel may work to improve the accuracy of the force detection. In this way, the power consumption of the display panel can be further decreased and force detection caused by erroneous operation can be avoided. For example, the display panel is a part of a cellphone, when the cellphone is placed in a user's pocket, even if the user does not perform the touch operation, it may still cause stress on the display panel by a hard object such as a key, and if such press is decided to be a force-sensitive control performed by the user, it may cause erroneous operation and increase the power consumption of the display panel. In the present embodiment, firstly the touch detection is performed by the touch electrode 3 in the touch detection mode, and then the second force sensors 12 are controlled to start working when it is determined that a touch operation is performed by the user, and then the force-sensitive pre-detection mode is entered.

In an embodiment, the control device 2 is further configured to, when the output signal of the touch electrode 3 does not reach the second preset condition within the second preset time, stop outputting the bias voltage to the input end of each second force sensors 12.

In the force-sensitive pre-detection mode, if the output signal of the touch electrode 3 does not reach the second preset condition within the second preset time, it indicates that the touch operation by the user has ended. In order to further decrease power consumption, it is possible to stop outputting the bias voltage to the input end of each second force sensors 12, that is, the display panel re-enters the touch detection mode, until it is detected for a next time that the output signal of the touch electrode 3 reaches the second preset condition, then the force-sensitive pre-detection mode is re-entered again.

In an embodiment, as shown in FIG. 2, there is a plurality of touch electrodes 3. The control device 2 is configured to acquire an output signal of each touch electrode 3 and, when the output signal of any one of the touch electrodes 3 reaches the second preset condition, output a bias voltage to the input end of each second force sensors 12.

When the display panel has a plurality of touch electrodes 3, the touch detection can be performed on a large area, so as to achieve more complicated touch operations. In the touch detection mode, as long as the output signal of any one of the touch electrodes 3 reaches the second preset condition, it indicates that a touch operation is performed on the display panel, and the force-sensitive pre-detection mode is entered.

It should be noted that, in another possible implementation manner, the touch electrode may also be a touch electrode included in a specific functional key. For example, the display panel has a functional key for turning on the screen, and the functional key has a touch electrode. When the user starts to use the display panel, he/she firstly may need to click the functional key, at this time, it indicates that the user may need to operate, and the force-sensitive pre-detection mode is entered for further deciding whether the user performs a force-sensitive operation.

In an embodiment, as shown in FIG. 2, there is a plurality of touch electrodes 3; the control device 2 is configured to, when the output signal of each of the touch electrodes 3 does not reach the second preset condition within the second preset time, stop outputting the bias voltage to the input end of each second force sensors 12.

When the display panel has a plurality of touch electrodes 3, when the output signal of each of the touch electrodes 3 does not reach the second preset condition within the second preset time, it indicates that the touch operation by the user has ended. In order to further decrease power consumption, it is possible to stop outputting the bias voltage to the input end of each second force sensors 12, that is, the display panel re-enters the touch detection mode, until it is detected for a next time that the output signal of the touch electrode 3 reaches the second preset condition, then the force-sensitive pre-detection mode is re-entered again.

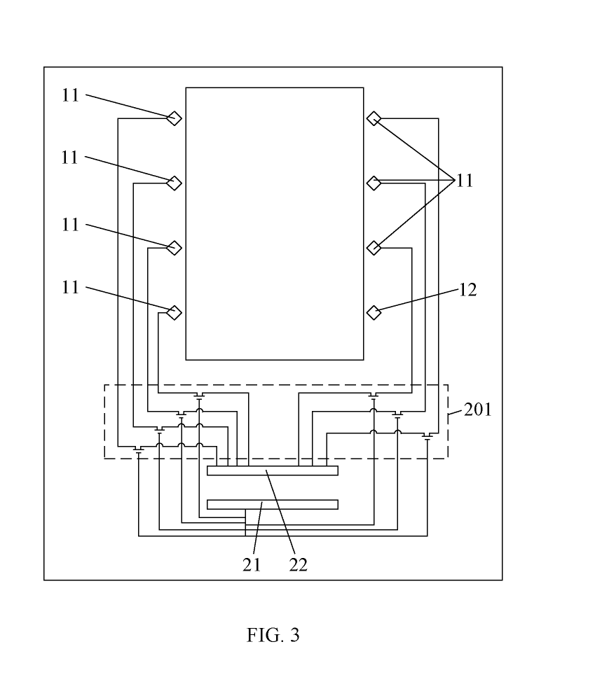

In an embodiment, on the basis of the structure shown in FIG. 1, as shown in FIG. 3, FIG. 3 is a structural schematic diagram of another display panel in an embodiment of the present disclosure. The control device 2 includes a chip 21, the chip 21 being connected with the output end of each first force sensors 11 and the output end of each second force sensors 12; a bias voltage input circuit 22 and a first switch device 201, the bias voltage input circuit 22 being connected with the input end of each first force sensors 11 via the first switch device 201; the chip 21 is also connected with an control end of the first switch device 201, the chip 21 is configured to, when the bias voltage is output to the input end of each first force sensors 11, control the first switch device 201 to allow the input end of each first force sensors 11 to be conductive with the bias voltage input circuit 22.

In the structure as shown in FIG. 1, it can be controlled directly by the chip whether the bias voltage is output to the input end of the force sensor, and it may also be like the structure as shown in FIG. 3, it can be controlled by cooperation of the switch device whether the bias voltage is output to the input end of the force sensor. The bias voltage input circuit 22 is used to provide a bias voltage required by the force sensor, the first switch device 201 is used to control the turn-on and turn-off between the input end of the first force sensors 11 and the bias voltage input circuit 2. It should be noted that, the chip 21 and the bias voltage input circuit 22 can be separate devices or the bias voltage input circuit 22 can be integrated on the chip, as long as the corresponding functions can be achieved. In addition, the first switch device 201 may include a thin film transistor corresponding to each first force sensors 11, a first end of each thin film transistor is connected with the input end of the corresponding first force sensors 11, a second end of each thin film transistor is connected with the bias voltage input circuit 22, a control end of each thin film transistor is connected with the chip 21. When the thin film transistors are of the same control type, for example, the thin film transistors are all N-type thin film transistors or all P-type thin film transistors, the control ends of the thin film transistors can be connected with the same pin of the chip 21, so as to reduce the number of the pin in the chip. All the thin film transistors in the first switch device 201 can be controlled to be simultaneously turned on or off by a signal from the same pin.

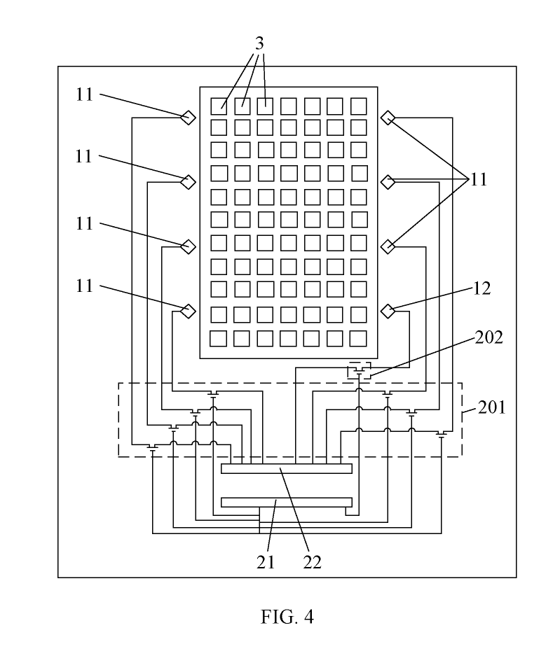

In an embodiment, on the basis of the structure shown in FIG. 2, as shown in FIG. 4, FIG. 4 is a structural schematic diagram of another display panel in an embodiment of the present disclosure. The control device 2 includes a chip 21, the chip 21 being connected with the output end of each first force sensors 11 and the output end of each second force sensors 12; a bias voltage input circuit 22, a first switch device 201 and a second switch device 202, the bias voltage input circuit 22 being connected with the input end of each first force sensors 11 via the first switch device 201, and the bias voltage input circuit 22 being connected with the input end of each second force sensors 12 via the second switch device 202; the chip 21 is also connected with an control end of the first switch device 201 and the second switch device 202, the chip 21 is configured to, when the bias voltage is output to the input end of each first force sensors 11, control the first switch device 201 to allow the input end of each first force sensors 11 to be conductive with the bias voltage input circuit 22, and when the bias voltage is output to the input end of each second force sensors 12, control the second switch device 202 to allow the input end of each second force sensors 12 to be conductive with the bias voltage input circuit 22

In the structure as shown in FIG. 2, it can be controlled directly by the chip whether the bias voltage is output to the input end of the force sensor, and it may also be like the structure as shown in FIG. 4, it can be controlled by cooperation of the switch device whether the bias voltage is output to the input end of the force sensor. Similar to the structure shown in FIG. 3, in the structure shown in FIG. 4, the bias voltage input circuit 22 is used to provide a bias voltage required by the force sensor, the first switch device 201 is used to control the turn-on and turn-off between the input end of the first force sensors 11 and the bias voltage input circuit 22, the second switch device 202 is used to control the turn-on and turn-off between the input end of the second force sensors 12 and the bias voltage input circuit 22. It should be noted that, the chip 21 and the bias voltage input circuit 22 can be separate devices or the bias voltage input circuit 22 can be integrated on the chip, as long as the corresponding functions can be achieved.

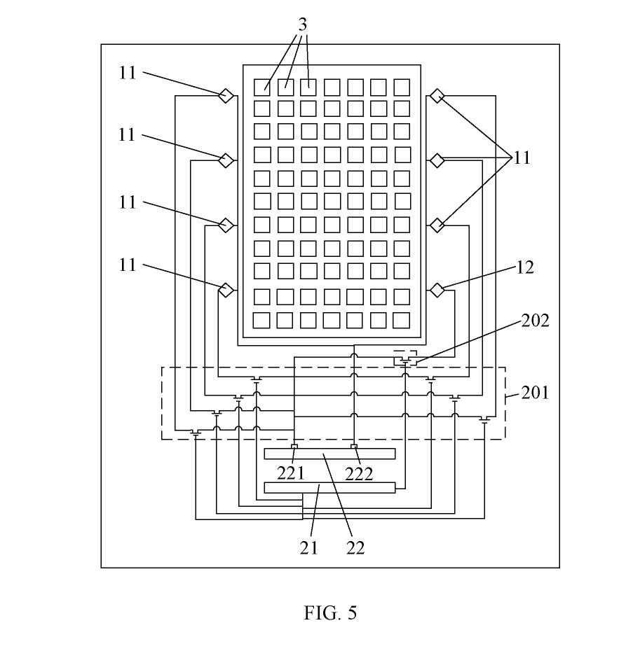

In an embodiment, as shown in FIG. 5, FIG. 5 is a structural schematic diagram of another display panel in an embodiment of the present disclosure. Each first force sensors 11 includes a first input end and a second input end. The first input end of the first force sensors 11 are connected with a first input end 221 of the bias voltage input circuit 22 via the first switch device 201, and the second input end of the first force sensors 11 are connected with a second input end 222 of the bias voltage input circuit 22.

The first input end 221 and the second input end 222 of the bias voltage input circuit 22 are used to provide a bias voltage. For example, the first input end 221 of the bias voltage input circuit 22 provides a high-level signal, the second input end 222 of the bias voltage input circuit 22 provides a zero potential, it is only necessary that the first switch device 201 controls the turn-on and turn-off between the first input end of each first force sensors 11 and the first input end 221 of the bias voltage input circuit 22, and then it can achieve controlling whether the first force sensors 11 works or not, the second input end of each first force sensors 11 may be directly connected with the second input end 222 of the bias voltage input circuit 22. It can be understood that, in another implementable manner, the second input end of each first force sensors 11 may also be connected with the second input end 222 of the bias voltage input circuit 22 via the first switch device 201, that is, the first input device 201 may simultaneously control turn-on and turn-off between two input ends of each first force sensors 11 and the bias voltage input circuit 22.

In an embodiment, as shown in FIG. 5, each second force sensors 12 includes a first input end and a second input end, the first input end of the second force sensors 12 are connected with the first input end 221 of the bias voltage input circuit 22 via the second switch device 202, the second input end of the second force sensors 12 are connected with the second input end 222 of the bias voltage input circuit 22.

When the display panel has the above-mentioned touch detection mode, it is necessary to control whether the second force sensors 12 works or not. It is only necessary that the second switch device 202 controls the turn-on and turn-off between the first input end of each second force sensors 12 and the first input end 221 of the bias voltage input circuit 22, and then it can achieve controlling whether the second force sensors 12 works or not, the second input end of each second force sensors 12 may be directly connected with the second input end 222 of the bias voltage input circuit 22. It can be understood that, in another implementable manner, the second input end of each second force sensors 12 may also be connected with the second input end 222 of the bias voltage input circuit 22 via the second switch device 202, that is, the second input device 202 may simultaneously control turn-on and turn-off between two input ends of each second force sensors 12 and the bias voltage input circuit 22.

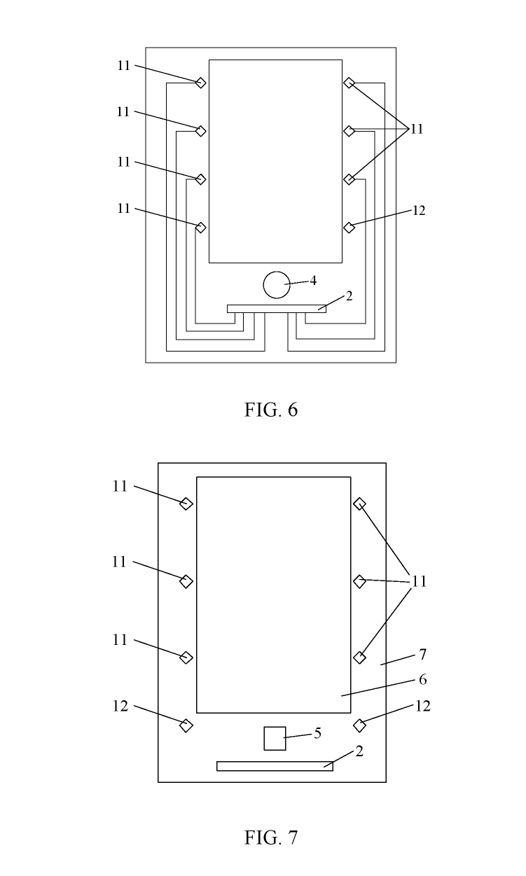

In an embodiment, as shown in FIG. 6, FIG. 6 is a structural schematic diagram of another display panel in an embodiment of the present disclosure. The display panel further includes a fingerprint identification device 4 connected with the control device 2; the control device 2 is further configured to acquire an output signal of the fingerprint identification device 4 and, when the output signal of the fingerprint identification device 4 is a fingerprint verification success signal, output the bias voltage to the input end of each first force sensors 11.

In addition to the above manner of detecting whether a touch operation is performed on the display panel by the touch electrode as a basis for whether to enter the force-sensitive pre-detection mode or not, the display panel may also be triggered to enter the force-sensitive pre-detection mode in the following manner, for example, the cellphone has a display panel with a fingerprint identification device 4 and the fingerprint identification device 4 is used for unlocking the cellphone, when the output signal of the fingerprint identification device 4 is a fingerprint verification success signal, it indicates that the user unlocks the cellphone by means of fingerprint and may use the cellphone then, at this time, the bias voltage can be output to the input end of each first force sensors 11 so as to enter the force-sensitive pre-detection mode.

In an embodiment, as shown in FIG. 7, FIG. 7 is a structural schematic diagram of another display panel in an embodiment of the present disclosure. The display panel further includes a screen wake-up functional key 5 connected with the control device 2; the display panel includes a display area 6 and a non-display area 7; each second force sensors 12 and the screen wake-up functional key 5 are located in the non-display area 7, and each second force sensors 12 and the screen wake-up functional key 5 are located at the same side of the display area 6.

For example, the display panel is provided with totally two second force sensors 12, the second force sensors 12 and the screen wake-up functional key 5 are disposed at the lower portion of the display area 6. The screen wake-up functional key 5 may be a physical button or a virtual button. The display panel has a display state and a non-display state during working. When the user may not need to use the display panel, the display panel is in the non-display state. When the user may need to use the display panel, the screen wake-up functional key 5 may need to be clicked to trigger the display panel to enter the display state, so as to realize the display function. Therefore, both the second force sensors 12 and the screen wake-up functional key 5 are arranged at the same side of the display area 6, that is, the second force sensors 12 are arranged close to the screen wake-up functional key 5, when the user presses the screen wake-up functional key 5, the strain on the display panel may more easily cause the output signal of the second force sensors 12 to reach the first preset condition, thereby triggering the display panel into the force-sensitive detection mode.

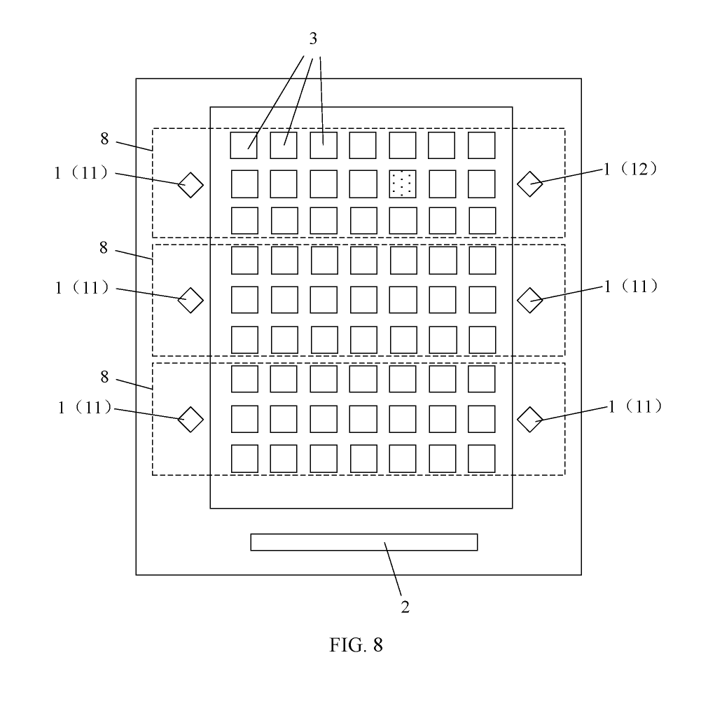

In an embodiment, as shown in FIG. 8, FIG. 8 is schematic diagram of a state of another display panel in an embodiment of the present disclosure. The display panel further includes: a plurality of touch electrodes 3 connected with the control device 2; the display panel includes a plurality of press areas 8, each press area 8 is provided with one or more force sensor 1 and one or more touch electrode 3; the control device 2 is further configured to acquire an output signal of each touch electrode 3, when an output signal of the touch electrode 3 in any one of the pressing areas 8 reaches the second preset condition, one or more force sensor 1 in the corresponding press area 8 acts as a second force sensors 12. Among the plurality of press areas 8, all of the force sensors 1, except for those being used as the second force sensors 12, are used as the first force sensors 11.

For example, as shown in FIG. 8, the display panel includes three press areas 8, when the user performs a touch operation somewhere in a certain press area 8, the output signal of a corresponding touch electrodes 3 (the dot-fill touch electrode 3 in FIG. 8) reaches the second preset condition, at this time, one or more force sensor 1 in this press area 8 acts as a second force sensors 12, and the other force sensors 1 in the plurality of press areas 8 act as the first force sensors 11, that is, the force sensor 1 closer to the touch location can be used to decide whether the user is performing a force-sensitive operation, and if so, the force-sensitive detection mode is entered. Such a force-sensitive pre-detection manner can more accurately determine whether the user is performing a force-sensitive operation. If the press areas are not divided, but the first force sensor and the second force sensor are respectively arranged at a fixed location, then when the user performs a force-sensitive operation at a location far from the second force sensor, the strain of the display panel has a smaller influence on the second force sensor, which may result in a failure of determining the user's force-sensitive operation. In the display panel shown in FIG. 8, by dividing of the press areas 8, a force sensor 1 in the same press area 8 acts as a second force sensors 12, therefore, when the force-sensitive pre-detection is performed, since the second force sensors 12 are closer to the touch location, so that it is possible to more accurately determine whether the user performs a force-sensitive operation.

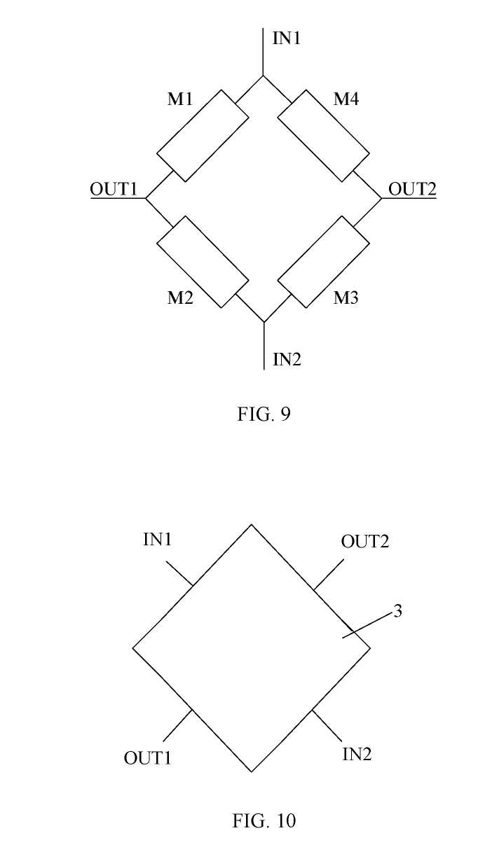

In an embodiment, as shown in FIG. 9, FIG. 9 is a structural schematic diagram of a force sensor in an embodiment of the present disclosure. Each force sensor is a Wheatstone bridge force sensor. The Wheatstone bridge force sensor includes a first input end IN1, a second input end IN2, a first output end OUT1 and a second output end OUT2. A first resistor M1 is connected in series between the first input end IN1 and the first output end OUT1, a second resistor M2 is connected in series between a first output end OUT1 and the second input end IN2, a third resistor M3 is connected in series between the second input end IN2 and the second output end OUT2, and a fourth resistor M4 is connected in series between the second output end OUT2 and the first input end IN1.

When the display panel is not deformed, when the ratio of the resistances of the first resistor M1 and the second resistor M2 is equal to the ratio of the resistances of the fourth resistor M4 and the third resistor M3, the bridge reaches an equilibrium state, the voltage value at the first output end OUT1 is equal to the voltage value at the second output end OUT2; when the display panel is deformed, all the above four resistors may be deformed, causing the resistance of each resistor to change, so that the equilibrium state of the bridge is interrupted, that is, the ratio of the resistances of the first resistor M1 and the second resistor M2 is not equal to the ratio of the resistances of the fourth resistor M4 and the third resistor M3, the voltage value at the first output end OUT1 is not equal to the voltage value at the second output end OUT2, the difference between the voltage value at the first output end OUT1 and the voltage value at the second output end OUT2 corresponds to the force value on the display panel, during the force detection process, the corresponding force value can be achieved by obtaining the voltage value at the first output end OUT1 and the voltage value at the second output end OUT2.

In an embodiment, as shown in FIG. 10, FIG. 10 is a structural schematic diagram of another force sensor in an embodiment of the present disclosure, each force sensor is a silicon piezoresistive force sensor.

The silicon piezoresistive force sensor may be formed as a quadrilateral structure, and the four edges are connected with a first input end IN1, a second input end IN2, a first output end OUT1 and a second output end OUT2, respectively, the first input end IN1 and the second input end IN2 are respectively connected with two opposite edges, the first output end OUT1 and the second output end OUT2 are respectively connected with the other two opposite edges. The first input end IN1 and the second input end IN2 apply a bias voltage to the silicon piezoresistive force sensor, when the display panel is pressed and thus deformed, the resistance of the silicon piezoresistive force sensor changes, the output signals of the first output end OUT1 and the second output end OUT2 correspondingly changes, the force applied to the silicon piezoresistive force sensor is detected by obtaining the change of the voltage at the first output end OUT1 and the second output end OUT2.

It should be noted that, the display panel in the embodiments of the present disclosure may be a liquid crystal display panel or an organic light emitting display panel, and may also be other types of display panels, which is not limited herein.

In an embodiment, the display panel may be a liquid crystal display panel, the liquid crystal display panel includes an array substrate and a color film substrate disposed opposite to the array substrate, and a liquid crystal layer is disposed between the array substrate and the color film substrate. A plurality of gate lines and a plurality of data lines are arranged on the array substrate in a crisscross manner, the plurality of gate lines and the plurality of data lines define a plurality of pixel units, each of the pixel units is provided with a thin film transistor and a pixel electrode, the gate electrode is electrically connected with the gate line, the source electrode is electrically connected with the data line, and the drain electrode is electrically connected with the pixel electrode. The color film substrate includes a grid-shaped black matrix and a plurality of color-resistors arranged in an array in the opening of black matrix, the color-resistors include red color-resistors, green color-resistors and blue color-resistors. The array substrate or the color film substrate is further provided with a common electrode, so that the deflection of the liquid crystal molecules is controlled by the electric field between the pixel electrode and the common electrode. In this case, the display device further includes a backlight module located at a side of the array substrate away from the color film substrate, and the backlight module provides light to the display panel.

In an embodiment, the display panel may be an organic light-emitting display panel, the organic light-emitting display panel includes an array substrate including a plurality of pixel circuits, and the organic light-emitting display panel further includes a plurality of organic light-emitting diodes (Organic Light-Emitting Diode, OLED) disposed on the array substrate, an anode of each OLED is correspondingly electrically connected with the pixel circuit on the array substrate, the plurality of light emitting diodes includes light emitting diodes for emitting red light, light emitting diodes for emitting green light, and light emitting diodes for emitting blue light. In addition, the organic light-emitting display panel may further include a packaging layer covering the plurality of OLEDs.

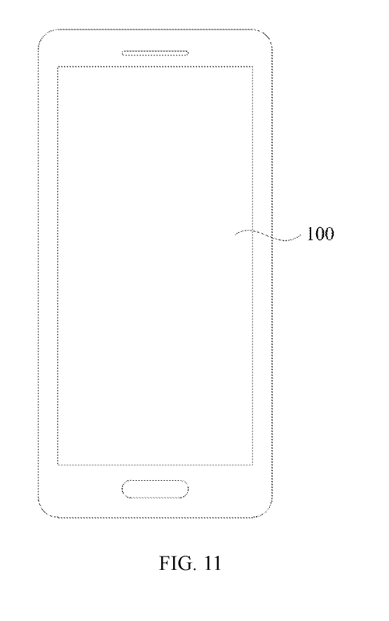

As shown in FIG. 11, FIG. 11 is a structural schematic diagram of a display device in an embodiment of the present disclosure. The present disclosure further provides a display device, including the above display panel 100.

The specific structure and principle of the display panel 100 are the same as those in the above embodiments, which will not be described herein. The display device can be any display device such as a touch screen, a cellphone, a tablet, a laptop or a TV, etc.

As for the display device in the embodiment of the present disclosure, first the input end of the second force sensor is provided with a bias voltage in the force-sensitive pre-detection mode, so that only the second force sensor works in the force-sensitive pre-detection mode while the first force sensor does not work, so the power consumption in the force-sensitive pre-detection mode is relatively low, when the output signal of the second force sensor reaches the first preset condition, it indicates that there is a pressing operation on the display panel, and now the display panel is in the force-sensitive detection mode, and the input end of the first force sensor is provided with the bias voltage, so that a greater number of force sensors can work in the force-sensitive detection mode, thereby improving the accuracy of the force detection, and achieving a more accurate force detection for the display panel. Compared with the prior art, there is no need to provide the bias voltage to all force sensors during the operation of the display panel, thereby decreasing the power consumption of the display panel.

Finally, it should be noted that, the above-described embodiments are merely for illustrating the present disclosure but not intended to provide any limitation. Although the present disclosure has been described in detail with reference to the above-described embodiments, it should be understood by those skilled in the art that, it is still possible to modify the technical solutions described in the above embodiments or to equivalently replace some or all of the technical features therein, but these modifications or replacements do not cause the essence of corresponding technical solutions to depart from the scope of the present disclosure.

What is claimed is:

1. A display panel, comprising:
a control device;
one or more first force sensors, wherein each of the one or more first force sensors comprising an input end connected with the control device and an output end connected with the control device; and
one or more second force sensors, each of the one or more second force sensors comprising an input end and an output end, and the output end of each of the one or more second force sensors being connected with the control device;
wherein the control device is configured to acquire an output signal of the one or more second force sensors and, when the output signal of the one or more second force sensors reaches a first preset condition, output a bias voltage to the input end of each of the one or more first force sensors.

2. The display panel according to claim 1, further comprising:
a touch electrode connected with the control device;
wherein the control device is further configured to acquire an output signal of the touch electrode and, when the output signal of the touch electrode reaches a second preset condition, output a bias voltage to the input end of each of the one or more second force sensors.

3. The display panel according to claim 2, wherein
the number of the touch electrode is more than one;
the control device is further configured to acquire an output signal of each of the touch electrodes and, when the output signal of any one of the touch electrodes reaches the second preset condition, output a bias voltage to the input end of each of the one or more second force sensors.

4. The display panel according to claim 1, wherein
the control device is further configured to, when the output signal of the one or more second force sensors does not reach the first preset condition within a first preset time, stop outputting the bias voltage to the input end of each of the one or more first force sensors.

5. The display panel according to claim 2, wherein
the control device is further configured to, when the output signal of the touch electrode does not reach the second preset condition within a second preset time, stop outputting the bias voltage to the input end of each of the one or more second force sensors.

6. The display panel according to claim 5, wherein
the number of the touch electrode is more than one;
the control device is further configured to, when the output signals of all of the touch electrodes do not reach the second preset condition within the second preset time, stop outputting the bias voltage to the input end of each of the one or more second force sensors.

7. The display panel according to claim 1, wherein
the control device comprises:
a first switch device;
a chip connected with the output end of each of the one or more first force sensors, the output end of each of the one or more second force sensors, and a control end of the first switch device; and
a bias voltage input circuit, the bias voltage input circuit being connected with the input end of each of the one or more first force sensors via the first switch device;
wherein the chip is configured to, when outputting the bias voltage to the input end of each of the one or more first force sensors, control the first switch device to allow the input end of each of the one or more first force sensors to be conductive with the bias voltage input circuit.

8. The display panel according to claim 2, wherein
the control device comprises:
a first switch device;
a second switch device;
a chip, the chip being connected with the output end of each of the one or more first force sensors, the output end of each of the one or more second force sensors, a control end of the first switch device, and a control end of the second switch device; and
a bias voltage input circuit, the bias voltage input circuit being connected with the input end of each of the one or more first force sensors via the first switch device, and connected with the input end of each of the one or more second force sensors via the second switch device;
wherein the chip is configured to, when outputting a bias voltage to the input end of each of the one or more first force sensors, control the first switch device to allow the input end of each of the one or more first force sensors to be conductive with the bias voltage input circuit, and when outputting a bias voltage to the input end of each of the one or more second force sensors, control the second switch device to allow the input end of each of the one or more second force sensors to be conductive with the bias voltage input circuit.

9. The display panel according to claim 7, wherein
each of the one or more first force sensors comprises a first input end and a second input end, the first input end of the one or more first force sensors is connected with a first input end of the bias voltage input circuit via the first switch device, and the second input end of the first force sensors is connected with a second input end of the bias voltage input circuit.

10. The display panel according to claim 8, wherein
each of the one or more second force sensors comprises a first input end and a second input end, the first input end of the one or more second force sensors is connected with a first input end of the bias voltage input circuit via the second switch device, and the second input end of the one or more force sensors is connected with a second input end of the bias voltage input circuit.

11. The display panel of claim 1, further comprising:
a fingerprint identification device connected with the control device;
wherein the control device is further configured to acquire an output signal of the fingerprint identification device and, when the output signal of the fingerprint identification device is a fingerprint verification success signal, output a bias voltage to the input end of each of the one or more first force sensors.

12. The display panel according to claim 1, further comprising:
a screen wake-up functional key connected with the control device;
wherein the display panel has a display area and a non-display area; each of the one or more second force sensors and the screen wake-up functional key are located in the non-display area, and each of the one or more second force sensors and the screen wake-up functional key are located at the same side of the display area.

13. The display panel of claim 1, further comprising:
a plurality of touch electrodes connected with the control device;
wherein the display panel has a plurality of press areas, in each of the press areas one or more force sensors and one or more of the touch electrodes are provided;
the control device is further configured to acquire an output signal of each of the touch electrodes and, when the output signal of the touch electrode in any one of the press areas reaches a second preset condition, use one or more force sensors in a corresponding press area, as the second force sensors, and use force sensors among the plurality of press areas except the second force sensors, as the first force sensors.

14. The display panel according to claim 1, wherein
each force sensors is a Wheatstone bridge force sensors, the Wheatstone bridge force sensors comprises a first input end, a second input end, a first output end and a second output end, a first resistor is connected in series between the first input end and the first output end, a second resistor is connected in series between the first output end and the second input end, a third resistor is connected in series between the second input end and the second output end, and a fourth resistor is connected in series between the second output end and the first input end.

15. The display panel according to claim 1, wherein
each force sensors is a silicon piezoresistive force sensors.

16. A display device comprising a display panel, wherein the display panel comprises:
a control device;
one or more first force sensors, each of the one or more first force sensors comprising an input end connected with the control device and an output end connected with the control device; and
one or more second force sensors, each of the one or more second force sensors comprising an input end and an output end, and the output end of each of the one or more second force sensors being connected with the control device;
wherein the control device is configured to acquire an output signal of the one or more second force sensors and, when the output signal of the one or more second force sensors reaches a first preset condition, output a bias voltage to the input end of each of the one or more first force sensors.
